(19) United States
(12) Patent Application Publication
(10) Pub. No.: US 2013/0136286 A1
(43) Pub. Date: May 30, 2013

(54) ELECTRICAL WIRE CONNECTOR, METHOD FOR PRODUCING AN ELECTRICAL WIRE CONNECTOR AND HEARING AID

(71) Applicant: OTICON S/S, Smorum (DK)

(72) Inventors: Lars Steen CHRISTENSEN, Smorum (DK); Kenneth Rueskov MOLLER, Smorum (DK); Anders Hedelund NIELSEN, Smorum (DK)

(73) Assignee: Oticon A/S, Smorum (DK)

(21) Appl. No.: 13/683,791

(22) Filed: Nov. 21, 2012

Related U.S. Application Data
(60) Provisional application No. 61/563,620, filed on Nov. 25, 2011.

(30) Foreign Application Priority Data
Nov. 25, 2011 (EP) 11190741.6

(51) Int. Cl. H01R 12/59; H04R 25/00; H01R 43/00

(52) U.S. Cl. CPC H01R 12/59; H01R 43/00; H04R 25/556
USPC 381/330; 439/727; 29/874

(57) ABSTRACT

An electrical wire connector adapted to establish galvanic contact between a first device and a second device is provided where the connector wire includes: an outer tube of soft bendable material, and a plug at least at a first end of the wire connector facilitating galvanic contact with the first device, where the plug includes a housing which is mechanically coupled to the tube and surrounds at least an end portion of the tube, wherein further the tension relief fibre is coupled to the housing of the plug and/or to the end portion of the tube.

### AREA OF THE INVENTION

In certain types of electrical wire connectors it is desired, that the wire connector is soft and easily bendable, however, in case a soft bendable outer sheath or tube is used it will not withstand being pulled at, and especially in communication gear, the metal connectors inside the tube may be of a type which also are not able to carry much mechanical stress, and in this case there is a risk of the user inadvertently pulling the electrical wire connector apart in daily use.

### BACKGROUND OF THE INVENTION

It has been proposed to add a tension relief fibre to such wire connections however the fibre is in previous known products at least partially embedded in the tube material. This is not desired in the present application as this adds stiffness to the wire connector, which is highly undesirable in certain cases.

In us 2011/0194718 a receiver tube for a hearing aid has an integrated strain relief. A receiver mounted at the end of the receiver tube is normally worn in the auditory canal of a hearing aid wearer. It is pulled out of the canal by pulling at the receiver tube or also separated from the receiver tube for the purpose of cleaning or exchange. Due to the tensile forces, the flexible receiver tube is stretched and elongated. This longitudinal extension may under certain circumstances amount to up to several millimeters and load or even damage the connection of the less extensible conductor to the receiver or to the hearing aid extending through the receiver tube due to tension. According to the document it is proposed to make the conductors longer than the tube, such that extension of the tube will not lead to breakage of the conductors.

US 2003/0066676 discloses a cable with at least one flexible conductor and a non-conductive, elongated, strain relieving member bound mechanically to the conductor. The strain relieving member is mechanically attached between two relatively movable components. The electrical conductor is in turn electrically attached to contacts on the components. Movement of the components relative to one another will be limited by the strain relieving member thereby protecting a somewhat longer electrical conductor extending therebetween. Alternatively, a plurality of conductors can be integrally combined with the elongated strain relieving member, by braiding or twisting, to form a unitary cable which incorporates the strain relieving member.

### SUMMARY OF THE INVENTION

A strain relieving member is desired, which is simple to ad to existing systems of tubes and plugs to be used in electrical interconnection elements without having to effect larger changes on either the plugs or the wires.

An electrical wire connector adapted to establish galvanic contact between a first device and a second device is provided where the connector wire includes an outer tube of soft bendable material, and inside the tube insulated metal threads and a bendable tension relief fibre is provided, where a plug at least at a first end of the wire connector facilitates galvanic contact with the first device, and the plug includes a housing which is mechanically coupled to the tube and surrounds at least an end portion of the tube. In order to solve the above problem, the tension relief fibre is coupled to the housing of the plug and/or to the end portion of the tube. In this way systems may be used which are not structurally overly different from prior art systems, only now a soft tube may be provided, which will not in itself provide the strength to protect the soft metal threads or wires inside the tube.

Also a range of methods for assembling a wire connector of the above kind are provided. A first method as claimed in claim 6 the fibre is secured between the housing of the plug and the tube. This ensures a very strong connection, which is very easy to assemble.

Alternative methods are provided in claims 7 and 8.

Preferably the wire connector is used in a hearing aid.

It is intended that the structural features of the system described above, in the detailed description of ‘mode(s) for carrying out the invention’ and in the claims can be combined with the method, when appropriately substituted by a corresponding process. Embodiments of the method have the same advantages as the corresponding systems.

Further objects of the invention are achieved by the embodiments defined in the dependent claims and in the detailed description of the invention.

As used herein, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present, unless expressly stated otherwise. Furthermore, “connected” or “coupled” as used herein may include wirelessly connected or coupled. As used herein, the term “and/or” includes any and all combinations of one or more of the associated listed items. The steps of any method disclosed herein do not have to be performed in the exact order disclosed, unless expressly stated otherwise.

### BRIEF DESCRIPTION OF THE DRAWINGS

FIG. 1 is a wire connector with a plug at each its end,

FIG. 2a is an enlarged section through a plug adapted for connecting a hearing aid part behind the ear of a user,

FIGS. 2b and 2c are enlarged sections through a plug of the kind in FIG. 2a, but with the tension relief fibre in different configurations,

FIG. 2d is a sectional view through a further embodiment of the invention,

FIG. 2e is a sectional view through a further embodiment,

FIGS. 3a and 3b discloses essentially the same section through a behind the ear part of a hearing aid with a wire connection according to the prior art.

FIG. 4a discloses a further connection between the housing portion of a plug and the tension relief fibres in a 3d projection view,

FIG. 4b shows a housing portion of a plug as in FIG. 4a, but with a slightly different connection to the tension relief fibres,

FIG. 4c is a sectional view through a plug,

FIG. 4d is a 3d projection view of a housing portion of the plug in FIG. 4c,

FIG. 5a is wire connector with a plug at one end and a hearing aid part at the other,

FIG. 5b -5c shows various stages of assembly between the wire and a housing portion,

FIG. 5e is a 3d representation of a speaker inserted into a housing portion,

FIG. 6 shows a tube section with measures.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DESCRIPTION OF A PREFERRED EMBODIMENT

The figures are schematic and simplified for clarity, and they just show details which are essential to the understanding of the invention, while other details are left out. Throughout, the same reference numerals are used for identical or corresponding parts.

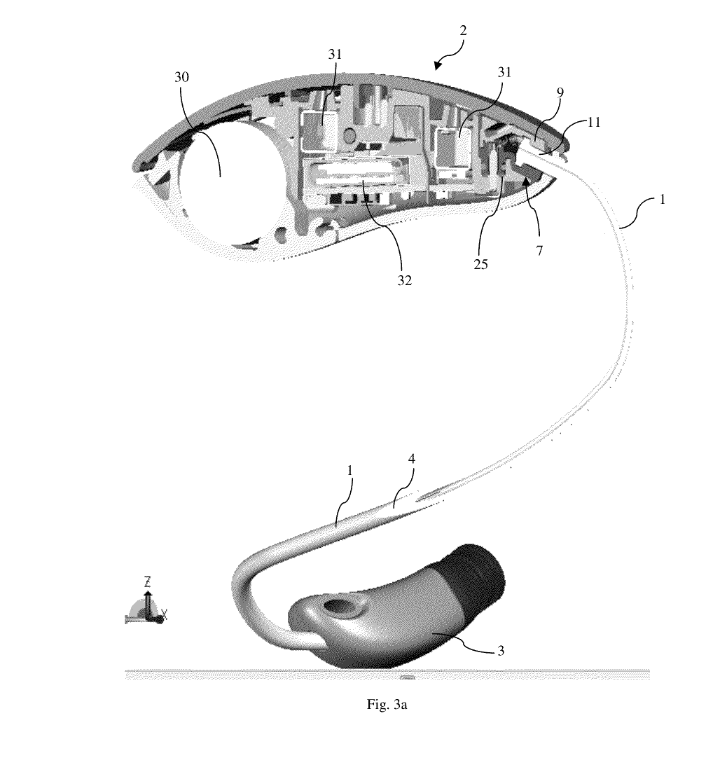

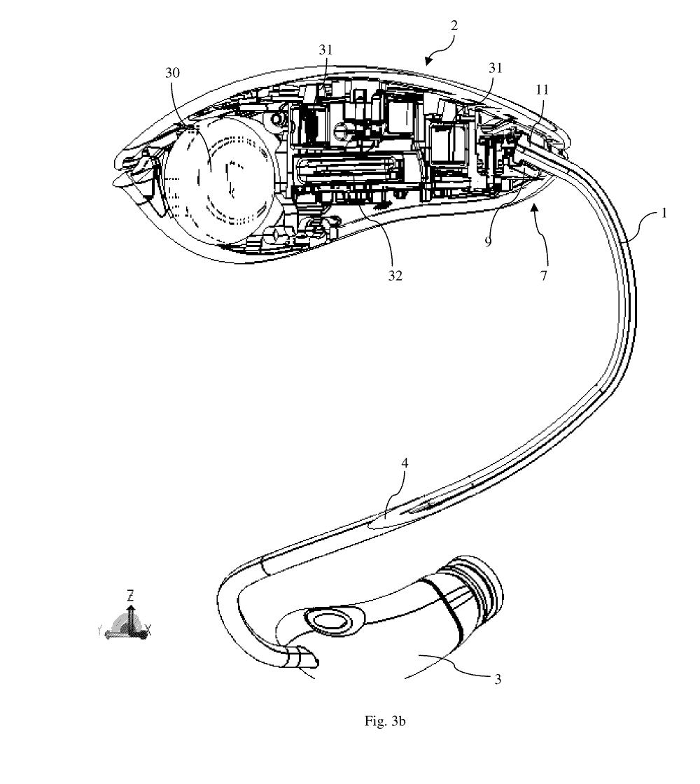

The prior art hearing aid in FIGS. 3a and 3b is shown in a partial sectional view. The hearing aid part 2 is to sit behind the ear of a user, and the part 3 is a speaker element to be entered into the ear canal of a user. A tube 4 with electric leads or wires is provided for establishing galvanic contact between the electrical elements in the two devices. The hearing aid 2 comprises a battery 30, microphones 31, a signal processing element 32. The electrical signals from the microphones is processed in the signal processing element 32, and an output signal is generated and served through the wires in the tube at a speaker or receiver inside the device 3. The device 3 at the ear or in the ear canal may also comprise a microphone or further electrical elements. In the prior art device the tube is sufficiently strong to protect the wires inside it against overload, which may occur in case the user inadvertently pulls the two devices away from each other.

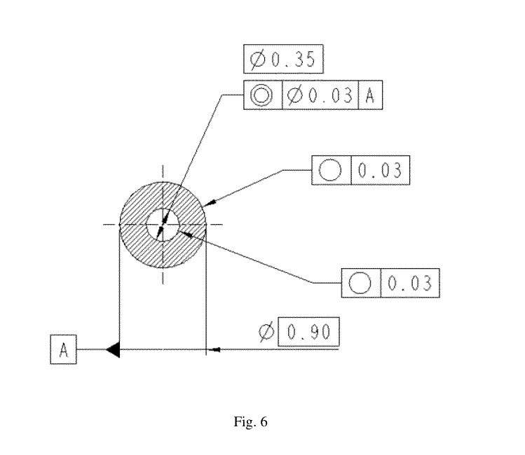

In the following, a new tube material is suggested which has a very long elongation at break, such as above 100%. When such a material is used for the tube, and a thinwalled tube is used as illustrated in FIG. 6. When this tube is pulled at, it will give way at relatively small forces and start to become longer, and this will result in the relatively weak leads inside being pulled over due to the tensile strength being down to 40 Mpa and the tube section comprising only a small area of material to carry the pulling force. The material in question has an elongation at break of no less than 148%, and thus long before the tube is pulled over, the leads inside will have suffered injury, and possibly the user is un-aware of this, as it is not readily visible from the outside, unless the units have been pulled apart. The construction material in question is a 75/25% Rilsan (™)/Pebax (™) blend which may be easily shaped into endless tubes in conventional extrusion processing. The use of a tension release fibre inside the tube is indispensable when a tube with the disclosed desirable dimensions and physical properties is used. The blend has several advantages over usual tubes, firstly it is easy to mould into the final costum shape and allows this moulding at low temperatures, and secondly it is soft to the touch of the user. Further, the low tensile strength will ensure, that also specimens which has not been perfectly moulded, will sit relatively well at the ear, and not cause the unit in the ear to be pressed against an internal wall of the ear canal.

A tension relief fibre, as used in this application may comprise a bundle of fibres of a material with high tensile strength such as aramid fibres. The bundle of fibres may be woven, spun or otherwise kept together. Preferably the fibre bundle comprise a drop of glue at each end in order to facilitate handling of the tension relief fibre. When in place in a hearing aid connector, this glued portion of the tension relief fibre is cut off.

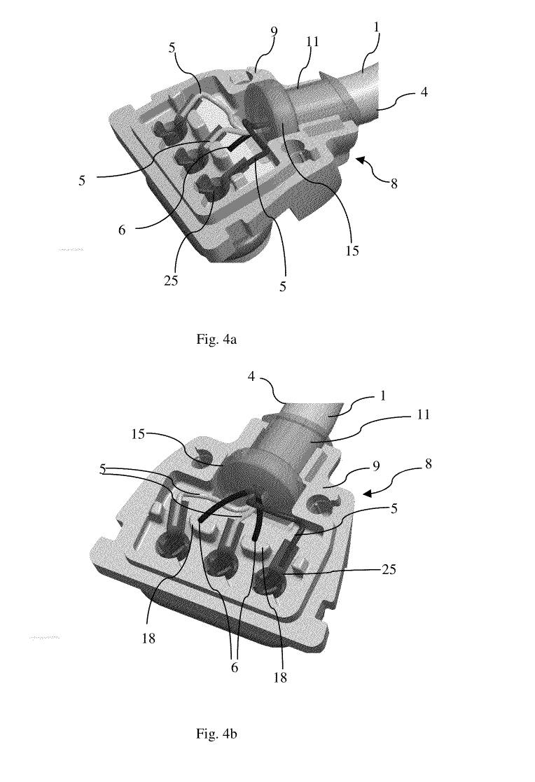

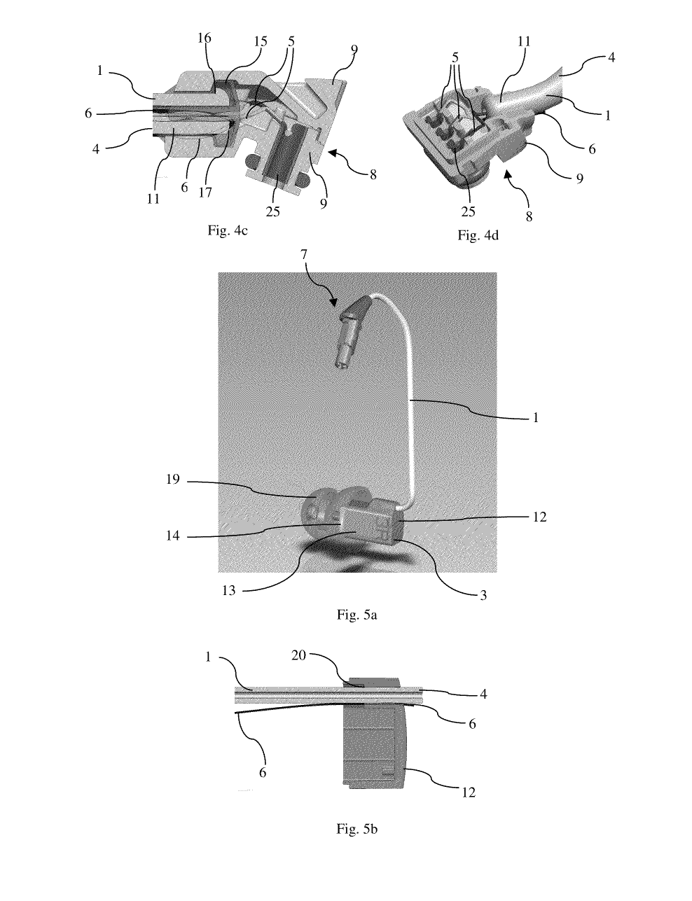

As disclosed in FIGS. 4a-4c, the connector wire 1 according to the invention includes an outer tube 4 of soft bendable material, and inside the tube insulated metal threads 5 and a bendable tension relief fibre 6 are provided. A plug 8 is provided at one end of the wire 1, and at the other end a device 3 or a further plug 8,7 or hearing aid part 3 is provided. The connector wire facilitates galvanic contact with the first device 2 through the plug 7,8. The plugs 7,8 includes a housing 9 which is mechanically coupled to the tube 4 and surrounds at least an end portion 11 of the tube. The housing 9 may include several members, and in FIGS. 4a and 4b only one member is shown, whereas in FIG. 4c two such members are disclosed, which combined by glue or other means surrounds the end portion 11 of tube 1.

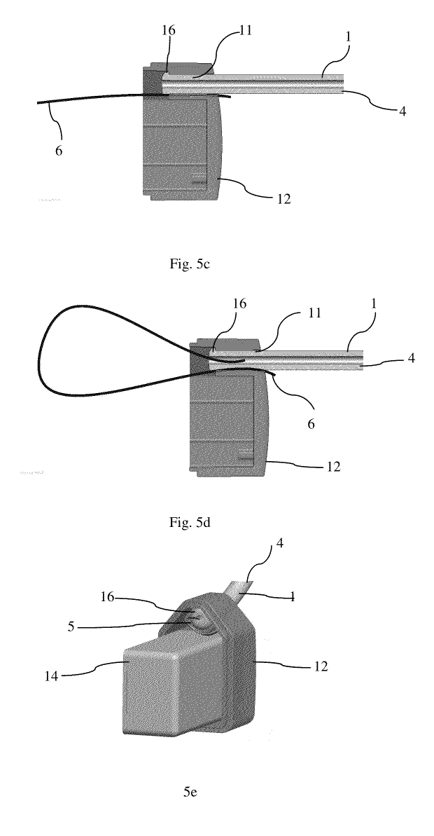

As seen in FIG. 5a-5c the end portion 11 may alternatively be connected directly to a housing 12 of the device 3, which in this case is adapted to be located at the ear canal (not shown) of a user.

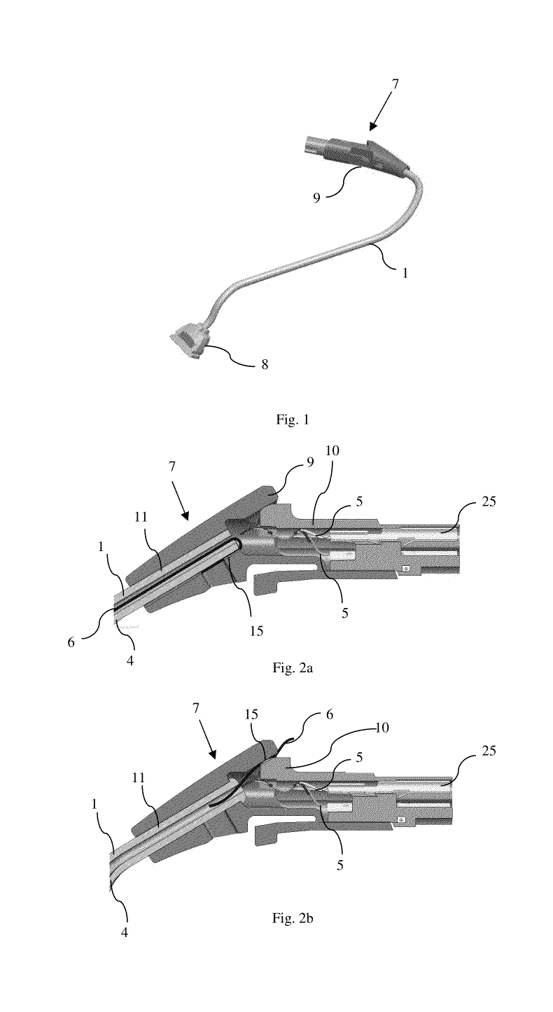

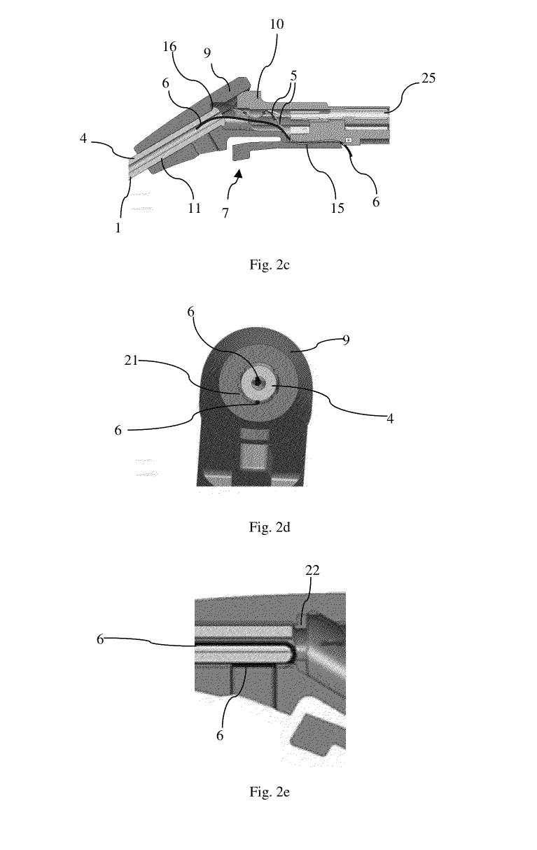

The plugs 7 in FIG. 2a-c differs from the plugs 8 in FIGS. 4a-4d, but the two kind of plugs performs the same basic function, namely to establish electrical connection between the leads inside the tube 4 and a device, this device being either a behind the ear type or in the ear type of hearing aid part.

A tension relief fibre 6 is coupled to the housing 9, 12 of the plug or device and/or to the end portion 11 of the tube 4. When the connector wire is subject to tension, the tube 4 will become longer due to its soft and flexible nature, and in order to not transfer tension to the metal threads 5 the relief fibre 6 is at both ends connected to either a housing portion or a device part and will thereby be able to carry the tension. By this arrangement a very soft and bendable tube 4 may be used. Preferably a transparent tube 4 is used. The tension relief fibres may be produced from known strong fibres such as aramid fibres, polyamide fibres, carbon fibres metal fibres or a single fibre made out of one or combinations of strong fibres.

The tension relief fibre 6 may be fastened to the tube 4 and/or to the housing 12,9 by means of glue 15.

As seen in FIGS. 2b and 2c the tension relief wire 6 may be wedged in between a first housing portion 9 and a second housing portion 10. In this solution glue 15 is usually added to ensure a safer connection between the tension relief fibre 6 and the housing 7.

Alternatively the fibre may be wedged in between an end portion 11 of the tube 4 and a housing 9, 12 of either a plug or a device. This is illustrated in FIGS. 4c, 5a-5d and 2a.

The sectional view in FIG. 2d of a further embodiment reveals guiding rails 21 in the housing portion 9 such that the tension relief fibre 6 between the tube 6 and housing 9 is guided into place at a predetermined location.

In FIG. 2e and enlarged section is disclosed of the embodiment in FIG. 2d, and here a stop flange 22 is provided in the housing portion 9 which ensures correct and placement of the tube 4 in the housing portion 9

As seen in FIG. 4c the tube 4 at its end portion 11 may have a radially, outward extending flange 16 shaped from the material of the tube 4 and a notch 17 provided in the flange such that the relief fibre 6 may be secured in the notch 17. As seen in FIGS. 2b, 2c and 5c-5d the flange 16 may well be present without the notch 17, whereby the flange serves the purpose of securing the tube to either a device or a plug.

In the embodiment of the invention shown in FIG. 4a, the tension relief fibre 6 is glued directly to a part inside the plug housing portion 9, and in FIG. 4b similarly the fibre 6 is glued to posts 18 inside the housing which may make the manual assembly easier.

In the embodiment shown in FIG. 5a the device 3 comprises a receiver housing, with a first part 12 and a second part 13 which together secures a speaker 14. Also in FIG. 5a a dome 19 is disclosed, intended to isolate the volume between the speaker 14 and the tympanic membrane once the device 3 is placed in the ear of a user. The first part 12 of the housing has a through going opening 20 with a profile allowing the tube 4 to fit tightly into this opening.

The securing of a tension relief fibre 6 between a housing and an endportion of a wire connector 1 as disclosed above may comprise the following steps: firstly
the metal threads 5 and the relief fibre 6 are introduced into the tube 4 to protrude out from the end portion 11 of the tube, secondly
the relief fibre 6 is bend back along the outer surface of the end portion of the tube 4, thirdly
the end portion 11 of the tube 4 with the relief fibre 6 at the outside thereof is introduced into the housing 9, and fourthly
the fibre is secured between the housing 9 and the end portion 11 of the tube through gluing.

This is a simple and easy to accomplish way of securing the tension relief fibre to the housing and tube, such that tension on tube will not stretch the metal wires.

In an alternative method firstly a first end portion of the fibre 6 is secured to the housing 12 inside a through-going opening 20 therein, the opening 20 being adapted to fit the exterior profile of the tube 4 as seen in FIG. 5b, and secondly as seen in FIG. 5c, the tube 4 is drawn through a through-going opening 20 in the housing 12, and fourthly a second end portion of the relief fibre 6 is drawn through the tube 4, as can be seen in FIG. 5d. In this way the fibre is secured between the housing 12 and the tube 4 in a very simple manner with a minimum of labour. The electrical wires are not disclosed in FIGS. 5a-5d, but they may be in the tube from the start or they may be introduced after assembly of housing portion and tube. In FIG. 5e the speaker 14 is seen inserted into the housing portion 12, and the electrical leads 5 are visible protruding from the tube 1.

A further method of securing a tension relief fibre between a housing and an endportion of a wire connector comprise the following steps: firstly the metal threads 5 and the relief fibre 6 are introduced into the tube 4 to protrude out from the end portion 11 of the tube 4, secondly a first housing portion of a plug is entered onto the tube by drawing the tube through a hole therein, thirdly the outwardly extending flange 16 is provided at the endportion 11 of the tube 4 and the first housing portion 9 is pulled towards the end portion 11 to abut the outwardly extending flange 16 (as seen in FIG. 2b), fourthly the tension relief fibre is secured between the first housing portion and a second housing portion as is also seen in FIG. 2b.

The above described method and wire connector is used for connecting hearing aid parts, particularly in hearing aids of the type comprising a first part adapted to reside behind the ear of a user, a second part adapted to reside at the ear canal of a user. The wire connector establishes a number of galvanic electrical mutually isolated electrical vias between the two parts, and as is visible in a number of the figures, the plugs comprises solid metal connectors 27 either as prongs (not shown) or sheaths adapted at one end as solder points for the wires and the other end to receive prongs.

1. Electrical wire connector adapted to establish galvanic contact between a first device and a second device where the connector wire includes: an outer tube of soft bendable material, and inside the tube insulated metal threads and a bendable tension relief fibre, a plug or a device part at least at a first end of the wire connector facilitating galvanic contact with the first device, where the plug or device part includes a housing which is mechanically coupled to the tube and surrounds at least an end portion of the tube, characterized in that the tension relief fibre is coupled to the housing or device part and/or to the end portion of the tube.

2. Electrical wire connector as claimed in claim 1, characterized in that the tension relief fibre is fastened to the tube and/or to the housing or device part by means of glue.

3. Electrical wire connector as claimed in claim 1 or claim 2, characterized in that the tension relief wire is wedged in between the outer surface of the tube and the housing or device part at the end portion of the tube.

4. Electrical wire connector as claimed in claim 1 or claim 2, characterized in that the tension relief wire is wedged in between a first and a second housing portion of a plug.

5. Electrical wire connector as claimed in claim 4, characterized in that the tube at its end portion has a radially, outward extending flange shaped from the material of the tube and a notch in the flange, whereby the relief fibre is secured in the notch.

6. Method of securing a tension relief fibre between a housing and an end portion of a wire connector as claimed in claim 1 wherein firstly
the metal threads and the relief fibre are introduced into the tube to protrude out from the end portion of the tube, secondly
the relief fibre is bend back along the outer surface of the end portion of the tube, thirdly
the end portion of the tube with the relief fibre at the outside thereof is introduced into the housing, and fourthly
the fibre is secured between the housing and the end portion of the tube through gluing.

7. Method of securing a tension relief fibre between a housing and an end portion of a wire connector as claimed in claim 1 wherein firstly
the metal threads and the relief fibre are introduced into the tube to protrude out from the end portion of the tube, secondly
a first housing portion of a plug is entered onto the tube by drawing the tube through a hole therein, thirdly
the outwardly extending flange is provided at the end portion of the tube and the first housing portion is pulled towards the end portion to abut the outwardly extending flange, fourthly
the tension relief fibre is secured between the first housing portion and a second housing portion.

8. Method of securing a tension relief fibre between a housing and an end portion of a housing in a wire connector as claimed in claim 1, wherein firstly
a first end portion of the fibre is secured to the housing inside a through-going opening in the plug or housing portion, the opening being adapted to fit the exterior profile of the tube, secondly
the tube is drawn through a through-going opening in the plug or housing portion, and fourthly
a second end portion of the relief fibre is drawn through the tube.

9. Hearing aid comprising a first part adapted to reside behind the ear of a user, a second part adapted to reside at the ear canal of a user, wherein an electrical wire connector as claimed in claim 1 is used to interconnect the two parts of the hearing aid.
